(19) United States
(12) Patent Application Publication
(10) Pub. No.: US 2023/0049058 A1
(43) Pub. Date: Feb. 16, 2023

(54) OVERLOAD PROTECTION MECHANISM FOR ELECTRICAL HEDGE TRIMMER

(71) Applicant: REXON INDUSTRIAL CORPORATION LTD., TAICHUNG CITY (TW)

(72) Inventors: Wan-Jie YOU, TAICHUNG CITY (TW); Yue-Yi LIN, TAICHUNG CITY (TW)

(21) Appl. No.: 17/888,584

(22) Filed: Aug. 16, 2022

(30) Foreign Application Priority Data
Aug. 16, 2021 (TW) 110130169

(51) Int. Cl. A01G 3/053; F16D 7/00

(52) U.S. Cl. CPC A01G 3/053; F16D 7/007; A01G 2003/0461

(57) ABSTRACT

An overload protection mechanism for use with an electrically hedge trimmer includes a transmission ring gear, a roller disposed in the transmission ring gear, a transmission shaft disposed in the transmission ring gear and eccentrically connected with two rocker arms, and a clutch member movably sleeved on the transmission shaft. When excessive resistance is applied to the rocker arms, the clutch member is pushed by the roller to compress an elastic member. This allows the transmission ring gear to be idled. When the resistance applied to the rocker arms is smaller than the rebound force provided by the elastic member, the clutch member is engaged with the roller, such that the transmission ring gear drives the transmission shaft to rotate through the clutch member.

Thus, the overload protection mechanism of the present invention carries out overload protection to the motor for extending the life of the motor.

### BACKGROUND OF THE INVENTION

### 1. Field of the Invention

The present invention relates to an electrical hedge trimmer and more particularly, to an overload protection mechanism for an electrical hedge trimmer.

### 2. Description of the Related Art

As far as an electrical hedge trimmer, the blades sometimes get stuck by thicker branches. If the motor continues to output power at this time, the motor may easily get damaged due to excessive load. To avoid this situation, the conventional electrical hedge trimmer provides an overload protection mechanism to protect the motor. Once the motor is overloaded, the power transmission relationship between the motor and the blades is eliminated by the overload protection mechanism, thereby achieving the purpose of protecting the motor.

### SUMMARY OF THE INVENTION

It is a primary objective of the present invention to provide an overload protection mechanism for an electrical hedge trimmer, which can effectively protect motor to extend the life of the motor. To attain the above objective, the overload protection mechanism of the present invention is used for the electrical hedge trimmer. The electrical hedge trimmer comprises a motor and a driving gear connected with the motor. The overload protection mechanism of the present invention comprises a transmission unit, a transmission shaft, two rocker arms, a clutch member, and a rebound elastic member. The transmission unit has a transmission ring gear and a roller. The transmission ring gear is engaged with the driving gear so as to be driven by the driven gear to rotate. Further, the transmission ring gear has a shaft hole, an inner flange disposed around the shaft hole, and a roller groove provided at the inner flange. The roller is rotatably disposed in the roller groove. The transmission shaft is rotatably disposed in the shaft hole of the transmission ring gear. The rocker arms are located at the same side of the transmission ring gear. One ends of the rocker arms are connected with blades, and the other ends of the rocker arms are eccentrically connected with the transmission shaft, such that the rocker arms are driven by the transmission shaft to drive the blades to operate one after the other. The clutch member is sleeved on the transmission shaft and movable along the axial direction of the shaft hole relative to the transmission ring gear and transmission shaft. In addition, the clutch member has a clutch groove fitted to the roller.

It can be seen from the above that when the blades get stuck by thicker branches, the transmission shaft does not work well due to resistance suffered by the rocker arms. At this time, the transmission ring gear is continuously driven by the motor. Once the resistance suffered by the rocker arms is greater than the elastic force of the rebound elastic member applied to the clutch member, the clutch member is pushed by the roller to move away from the transmission ring gear along the axial direction of the shaft hole. When the clutch member is moved to a separation position, the clutch groove is disengaged from the roller and the rebound elastic member is compressed, such that the transmission ring gear is idled together with the roller for achieving overload protection effect. When the sawing condition encountered by the blades is resolved, that is to say, the resistance suffered by the rocker arms is smaller than the elastic force of the rebound elastic member, the clutch member is pushed by the rebound elastic member to a coupling position where the clutch groove is engaged with the roller. At this time, the transmission ring gear drives the transmission shaft to rotate through the clutch member, and then the blades return to a normal use as desired.

Preferably, the axial direction of the roller is vertical to the axial direction of the axial hole. By this way, when the resistance applied to the rocker arms is greater than the elastic force of the rebound elastic member applied to the clutch member, the roller pushes against the clutch member to separate the clutch member from the transmission ring gear. When the resistance applied to the rocker arms is smaller than the elastic force of the rebound elastic member applied to the clutch member, the roller drives the clutch member to rotate together with the transmission ring gear.

Preferably, when the clutch member is located at the separation position, the roller is abutted against and rolled along the bottom surface of the clutch member.

Preferably, one end of the rebound elastic member is abutted against a spaced ring sleeved on the transmission shaft, and the other end of the rebound elastic member is abutted against the clutch member, such that the clutch member is pushed by the rebound elastic member towards the transmission ring gear.

Preferably, the spaced ring is fixed to the transmission shaft by a retaining ring secured to the transmission shaft.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of an electrical hedge trimmer using an overload protection mechanism according to an embodiment of the present invention.

FIG. 2 is a perspective view of the overload protection mechanism according to the embodiment of the present invention, in which a part of the housing is removed. FIG. 3 is a perspective view of the overload protection mechanism according to the embodiment of the present invention.

FIG. 4 is an exploded view of the overload protection mechanism according to the embodiment of the present invention.

FIG. 5 is a sectional view of the overload protection mechanism according to the embodiment of the present invention, showing that the clutch member is located at a coupling position.

FIG. 6 is similar to FIG. 5, showing that the clutch member is located at a separation position.

### DETAILED DESCRIPTION OF THE INVENTION

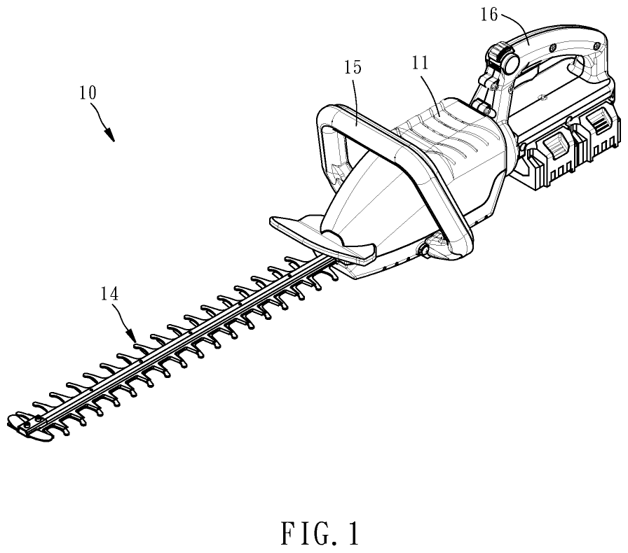

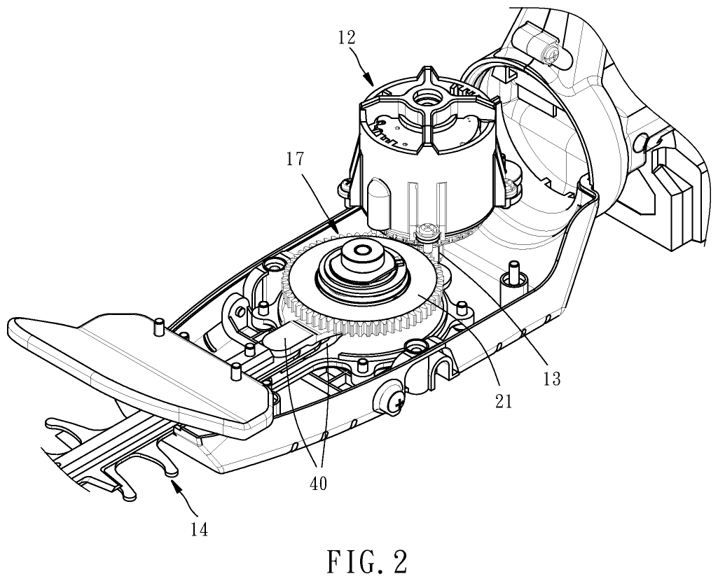

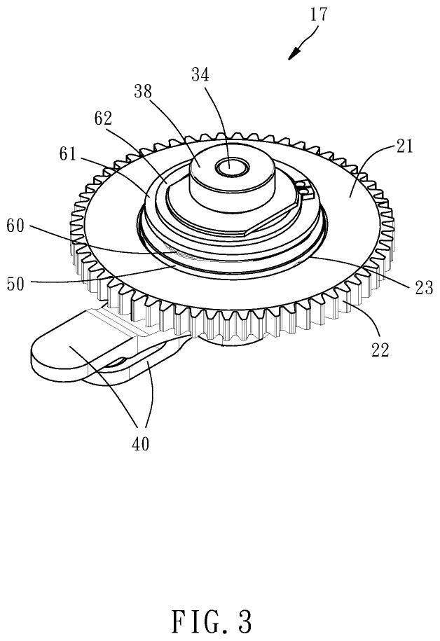

Referring to FIGS. 1 and 2, an electrical hedge trimmer 10 as shown in FIG. 1 comprises a housing 11, a motor 12 disposed in the housing 11, a driving gear 13 connected with the motor 12, two blades 14 located in front of the housing 11, a front handle 15 disposed above the housing 11, and a rear handle 16 disposed at the rear end of the housing 11. Because the aforesaid elements are not the key point of the present invention, the detailed configuration will not be repeatedly mentioned hereunder. As shown in FIGS. 2 to 4, the overload protection mechanism 17 of the present invention is disposed in the housing 11, comprising a transmission unit 20, a transmission shaft 30, two rocker arms 40, a clutch member 50, and a rebound elastic member 60.

The transmission unit 20 includes a transmission ring gear 21. The outer surface of the transmission ring gear 21 has a gear portion 22 engages with the driving gear 13, such that the transmission ring gear 21 is driven by the motor 12 to rotate through the driving gear 13. The transmission ring gear 21 further includes a circular shaft hole 23, an inner flange 24 provided at the inner surface of the transmission ring gear 21 and arranged around the center of the shaft hole 23, and three roller grooves 25 provided at the inner flange 24 and arranged in an equally-spaced manner with respect to the center of the shaft hole 23. In addition, the transmission unit 20 further includes three rollers disposed in the roller grooves 25 in a one-on-one manner. The axial direction of each roller 26 is vertical to the axial direction of the shaft hole 23, such that the rollers 26 are movable together with the transmission ring gear 21 and rotatable in the roller grooves 25. It needs to be added here that the number of the roller and the roller groove is not limited to three. The rollers and the roller grooves are adjustable in number according to actual needs as long as they are cooperated with each other.

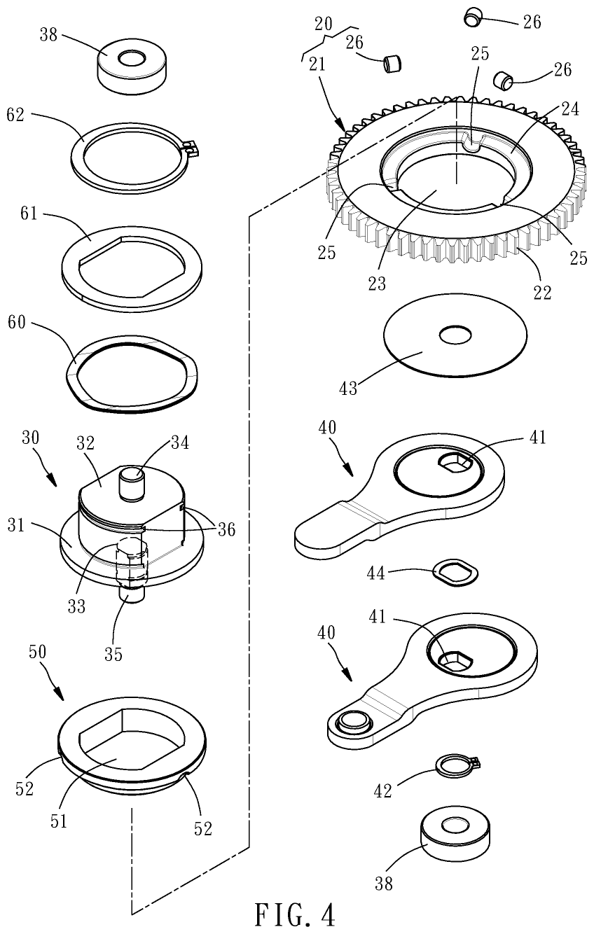

The transmission shaft 30 is penetrated into the shaft hole 23 of the transmission ring gear 21. As shown in FIG. 4, the transmission shaft 30 includes an annular portion 31, a first transmission portion 32, a second transmission portion 33, a first shaft portion 34, and a second shaft portion 35. The first and second transmission portions 32, 33 are integrally connected with the top and bottom surfaces of the annular portion 31, respectively. The first and second transmission portions 32, 33 both have non-circular cross-sectional shapes (here, a flat ovel shape is taken as an example). The major axis of the first transmission portion 32 is vertical to the major axis of the second transmission portion 33. In addition, a first retaining groove 36 is provided at each of two end surfaces of the first transmission portion 32. The first shaft portion 34 and the second shaft portion 35 are used for mounting with two bearings 38. The first shaft portion 34 are integrally connected with the top surface of the first transmission portion 32. The second shaft portion 35 are integrally connected with the bottom surface of the second transmission portion 33 and provided with a second retaining groove 37.

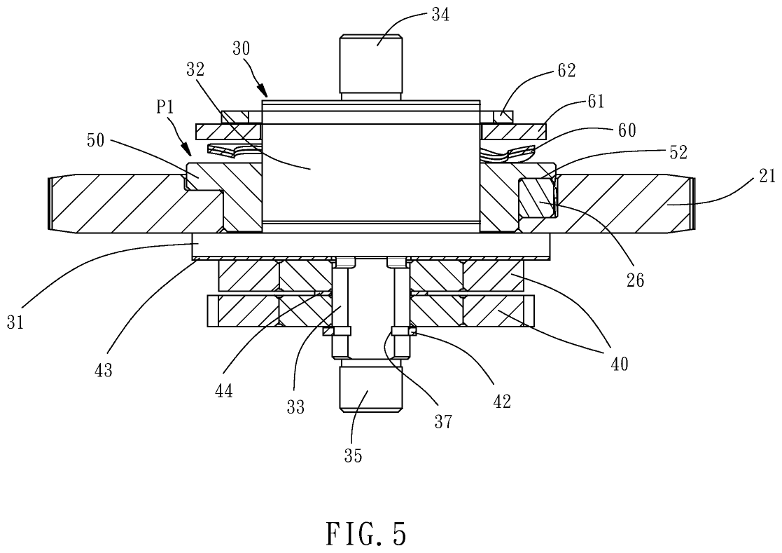

The rocker arms 40 are disposed at the same side of the transmission ring gear 21 in a side-by-side manner. The front ends of the rocker arms 40 are mounted with the blades 14, and the rear ends of the rocker arms 40 each have a non-circular eccentric hole 41 (here, a flat ovel shape is taken as an example). The eccentric holes 41 are arranged one after the other relative to the transmission shaft 30. The eccentric holes 41 of the rocker arms 40 are sleeved on the second transmission portion 33 of the transmission shaft 30 and obstructed by a second retaining ring 42 secured to the second retaining groove 37 without separation (as shown in FIG. 5). By this way, when the rocker arms 40 are driven by the transmission shaft 30, the rocker arms 40 drives the blades 14 to move one after the other. In addition, a washer 43 is provided between the annular portion 31 of the transmission shaft 30 and the upper rocker arm 40, and another washer 44 is provided between the rocker arms 40. The washers 43, 44 are used to reduce abrasion between each other.

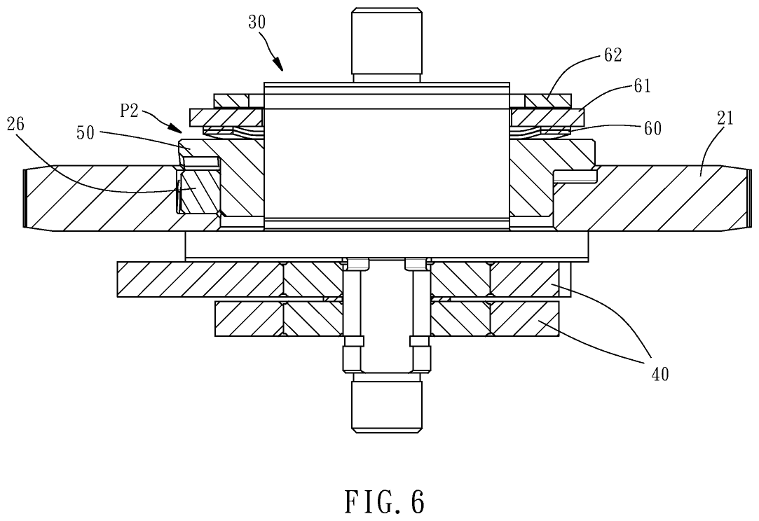

The clutch member 50 has a non-circular transmission hole 51 (here, a flat ovel shape is taken as an example). The transmission hole 51 of the clutch member 50 is sleeved on the first transmission portion 32 of the transmission shaft 30, such that the clutch member 50 is movable along the axial direction of the shaft hole 23 with respect to the transmission ring gear 21 and the transmission shaft 30. In addition, the bottom surface of the outer periphery of the clutch member 50 has three clutch grooves 52 fitted to the rollers 26. When the clutch member 50 is located at a coupling position P1 as shown in FIG. 5, the clutch grooves 52 of the clutch member 50 are engaged with the rollers 26. When the clutch member 50 is located at a separation position P2 as shown in FIG. 6, the clutch grooves 52 of the clutch member 50 are disengaged from the rollers 26.

As shown in FIGS. 4 and 5, the rebound elastic member 60 (here, a wave spring is taken as an example) is sleeved on the first transmission portion 32 of the transmission shaft 30. One end of the rebound elastic member 60 is abutted against a spaced ring 61 sleeved on the first transmission portion 32 of the transmission shaft 30 and fixed by a first retaining ring 62 secured to the first retaining groove 36, and the other end of the rebound elastic member 60 is abutted against the clutch member 50. By this way, the rebound elastic member 60 provides an elastic force to push the clutch member 50 towards the transmission ring gear 21.

When the blades 14 are driven to saw general thin branches, i.e., the resistance suffered by the rocker arms 40 is smaller than the elastic force of the rebound elastic member 60 applied to the clutch member 50, the clutch member 50 stays in the coupling position P1 as shown in FIG. 5, such that the clutch member 50 is pushed by the rollers 26 to rotate together with the transmission ring gear 21. Since the clutch member 50 is engaged with the first transmission portion 32 of the transmission shaft 30 through the non-circular transmission hole 51, the clutch member 50 will drive the transmission shaft 30 to rotate. This can keep the blades 14 in normal sawing state.

When the blades 14 get stuck by thicker branches, the transmission shaft 30 does not work well due to resistance applied to the rocker arms 40, and the transmission ring gear 21 is still driven by the motor 12. Once the resistance suffered by the rocker arms 40 is greater than the elastic force of the rebound elastic member 60 applied to the clutch member 50, the clutch member 50 is pushed by the rollers 26 to move to the separation position P2 as shown in FIG. 6. On one hand, the clutch grooves 52 are disengaged from the rollers 26, and the rollers 26 are abutted against and rolled along the bottom surface of the clutch member 50, and on the other hand, the rebound elastic member 60 is compressed to accumulate its rebound elastic force. As a result, the transmission ring gear 21 is idled along with the rollers 26 for providing an overload protection effect to the motor 12.

When the sawing condition encountered by the blades 14 is resolved, that is to say, the resistance suffered by the rocker arms 40 is smaller than the rebound force of the rebound elastic member 60, the clutch member 50 is pushed by the rebound elastic member 60 to move back to the coupling position P1 as shown in FIG. 5 where the clutch grooves 52 are engaged with the rollers 26 again. At this time, the clutch member 50 is pushed by the transmission ring gear 21 through the rollers 26, and thus the transmission shaft 30 is driven by the clutch member 50 to rotate, such that the blades 14 can return to a normal use as desired.

As indicated above, the overload protection mechanism 17 of the present invention uses the cooperation of the roller 26 and the clutch member 50 to release power transmission relationship between the transmission ring gear 21 and the transmission shaft 30 when the motor 12 is overloaded, thereby achieving purposes of protecting the motor 12 and extending life of the motor 12.

What is claimed is:

1. An overload protection mechanism for use with an electrically hedge trimmer comprising a motor and a driving gear connected with the motor, the overload protection mechanism comprising:
a transmission unit including a transmission ring gear engaged with the driving gear and having a shaft hole, an inner flange disposed around the shaft hole and a roller groove provided at the inner flange, and a roller rotatably disposed in the roller groove;
a transmission shaft rotatably disposed in the shaft hole of the transmission ring gear;
two rocker arms located at the same side of the transmission ring gear and eccentrically connected with the transmission shaft so as to be driven by the transmission shaft to move one after the other;
a clutch member movably sleeved on the transmission shaft and movable along an axial direction of the shaft hole relative to the transmission ring gear between a coupling position where a clutch groove of the clutch member is engaged with the roller, such that the clutch member is pushed by the transmission ring gear through the roller to drive the transmission shaft to rotate, and a separation position where the clutch groove of the clutch member is disengaged from the roller, such that the transmission ring gear is idled together with the roller; and
a rebound elastic member disposed on the clutch member to push the clutch member towards the transmission ring gear.

2. The overload protection mechanism as claimed in claim 1, wherein an axial direction of the roller is vertical to the axial direction of the shaft hole.

3. The overload protection mechanism as claimed in claim 1, wherein when the clutch member is located at the separation position, the roller is abutted against and rolled along a bottom surface of the clutch member.

4. The overload protection mechanism as claimed in claim 1, wherein a spaced ring is sleeved on the transmission shaft; one end of the rebound elastic member is abutted against the spaced ring, and the other end of the rebound elastic member is abutted against the clutch member.

5. The overload protection mechanism as claimed in claim 4, wherein the spaced ring is fixed by a retaining ring secured to the transmission shaft.
